(19) United States
(12) Patent Application Publication
(10) Pub. No.: US 2009/0159332 A1
(43) Pub. Date: Jun. 25, 2009

(54) CABLE SEAL ASSEMBLY

(76) Inventors: Matthew Holmberg, Le Center, MN (US); Yilmaz Bayazit, Saint Louis Park, MN (US); James J. Solheid, Lakeville, MN (US)

Correspondence Address: MERCHANT & GOULD PC, P.O. BOX 2903, MINNEAPOLIS, MN, 55402-0903, US

(21) Appl. No.: 12/256,796

(22) Filed: Oct. 23, 2008

Related U.S. Application Data
(60) Provisional application No. 60/982,975, filed on Oct. 26, 2007.

(51) Int. Cl. H02G 3/18; B23P 17/04

(52) U.S. Cl. 174/652; 174/650; 29/428

(57) ABSTRACT

A cable seal assembly includes a sealing member, a first housing member, and a second housing member. The sealing member defines a passageway that extends from a center opening of the sealing member through the periphery of the sealing member. The first housing member is disposed in the passageway and the center opening of the sealing member and defines a cutout portion. The second housing member is disposed in the center opening of the sealing member and engaged with the cutout portion of the first housing member. The first housing member and the second housing member cooperatively define a central axial passage having an inner surface.

### CROSS REFERENCE TO RELATED APPLICATIONS

This application claims the benefit of U.S. Provisional Patent Application Ser. No. 60/982,975, filed Oct. 26, 2007, which is hereby incorporated by reference in its entirety.

### TECHNICAL FIELD

The present disclosure relates generally to enclosures used with telecommunication networks, and more particularly, to a cable seal assembly used with such enclosures.

### BACKGROUND

Telecommunications networks often include cables that extend from central installations through one or more cabinets or enclosures to reach the customer. Within these enclosures, a variety of equipment may be mounted to provide signal processing, splitting or accumulation, and also may provide cross-connections between different cables. The enclosures provide security from accidental or intentional damage for the equipment mounted within and also provide weather protection from environmental damage. Cable entering the enclosure may pass through a cable seal which ensures a weather tight seal between the cable and the housing.

Once a cabinet has been assembled with equipment and has had cable led into the interior and connected to the equipment, it may be desirable to change the housing to replace damaged elements. Such damage might be caused by an automobile accidentally impacting the enclosure or a construction accident. It may also be desirable to change an undamaged portion of a pre-assembled cabinet for another portion which is a different color, to comply with customer needs. For changes made to the cabinet for any reason, known cabinet housings and cable seals require that an end of the cable pass through the cable seal. This may require cutting and reterminating many of the cables or elements of the cables extending into the cabinet. Improvements to existing cable seals and cabinet housings are desirable.

Additionally, it may be desirable to assemble a cabinet about a cable which has already been connected to equipment which will be mounted within the cabinet, rather than having to make the cable-equipment connections after mounting the equipment in the cabinet.

### SUMMARY

An aspect of the present disclosure relates to a cable seal assembly having a sealing member, a first housing member, a second housing member, and a cable seal. The sealing member defines a passageway that extends from a center opening of the sealing member through the periphery of the sealing member. The first housing member is disposed in the passageway and the center opening of the sealing member and defines a cutout portion. The second housing member is disposed in the center opening of the sealing member and engaged with the cutout portion of the first housing member. The first housing member and the second housing member cooperatively define a central axial passage having an inner surface.

Another aspect of the present disclosure relates to a cable seal assembly having a sealing member, a first housing member, and a second housing member. The sealing member includes a first leg portion, a second leg portion and a body portion having a front sealing surface and a side sealing wall. The first leg portion extends from a first end of the body portion while the second leg portion extends from a second end of the body portion. The first leg portion and the second leg portion define a passageway that leads to a center opening in the sealing member. The first housing member is disposed in the passageway and the center opening of the sealing member. The first housing member includes a cut-out portion. The first housing member is in sealing contact with the front sealing surface and the side sealing wall of the body portion and the first and second leg portions of the sealing member. The second housing member is disposed in the center opening of the sealing member and is in engagement with the cut-out portion of the first housing member. The second housing member is in sealing contact with the front sealing surface and the side sealing wall of the body portion of the sealing member.

Another aspect of the present disclosure relates to a cable sealing system having a sealing member that defines a passageway that extends from a center opening of the sealing member through the periphery of the sealing member. The cable sealing system also includes a first housing member and a second housing member with the first housing member disposed in the passageway and center opening of the sealing member and the second housing member disposed in the center opening of the sealing member. The first housing member defines a cutout portion. The second housing member is in engagement with the cutout portion of the first housing member. The first and second housing members cooperatively define a central axial passage having an inner surface. The cable sealing system also includes a fiber optic cable disposed in the central axial passage and a cable seal in sealing engagement with the central axial passage and the fiber optic cable. The cable seal includes a top member, a bottom member, a seal that is disposed between the top member and the bottom member and includes an outer periphery and a thru-hole, and a compression member adjacent to the top member and engaged with the bottom member. The compression member selectively compresses the seal thereby expanding the outer periphery of the seal into sealing engagement with the inner surface of the central axial passage and constricting the thru-hole into sealing engagement with the fiber optic cable.

A further aspect of the present disclosure relates to a method of installing a cable seal assembly. The method includes the steps of mounting a sealing member in a slot in a wall of an enclosure. The sealing member includes a center opening and a passageway that extends from the center opening through a periphery of the sealing member. An axial length of a fiber optic cable is inserted through a cutout portion of a first housing member and into a central axial passage of the first housing member. The second housing member is coupled to the cutout portion of the first housing member. The first and second housing members cooperatively define an inner surface of the central passage. The first and second housing members are mounted to the wall of the enclosure such that the first housing member is disposed in the passageway and center opening of the sealing member and the second housing member is disposed in the center opening of the sealing member. A cable seal is positioned around the fiber optic cable and inserted into the central axial passage. A compression member of the cable seal is actuated to expand the outer periphery of the seal such that the outer periphery of the cable seal sealingly engages the central passage and a thru-hole of the cable seal constricts such that the thru-hole sealingly engages the fiber optic cable.

A variety of additional inventive aspects will be set forth in the description that follows. The aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

FIG. 1 is a perspective view of a cable seal assembly having features that are examples of inventive aspects in accordance with the principles of the present disclosure.

FIG. 2 is an exploded perspective view of the cable seal assembly of FIG. 1.

FIG. 3 is a perspective view of a first housing member of the cable seal assembly of FIG. 1.

FIG. 4 is a top view of the first housing member of the cable seal assembly of FIG. 3.

FIG. 5 is a side view of the first housing member of the cable seal assembly of FIG. 3.

FIG. 6 is a perspective view of a second housing member of the cable seal assembly of FIG. 1.

FIG. 7 is a top view of the second housing member of the cable seal assembly of FIG. 6.

FIG. 8 is a side view of the second housing member of the cable seal assembly of FIG. 6.

FIG. 9 is a perspective view of a sealing member of the cable seal assembly of FIG. 1

FIG. 10 is a top view of the sealing member of the cable seal assembly of FIG. 9.

FIG. 11 is a side view of the sealing member of the cable seal assembly of FIG. 9.

FIG. 12 is a perspective view of the cable seal assembly of FIG. 1 and a fiber optic cable.

FIG. 13 is a fragmentary, cross-sectional view of the cable seal assembly taken on line 13-13 of FIG. 12.

### DETAILED DESCRIPTION

Reference will now be made in detail to the exemplary aspects of the present disclosure that are illustrated in the accompanying drawings. Wherever possible, the same reference numbers will be used throughout the drawings to refer to the same or like structure.

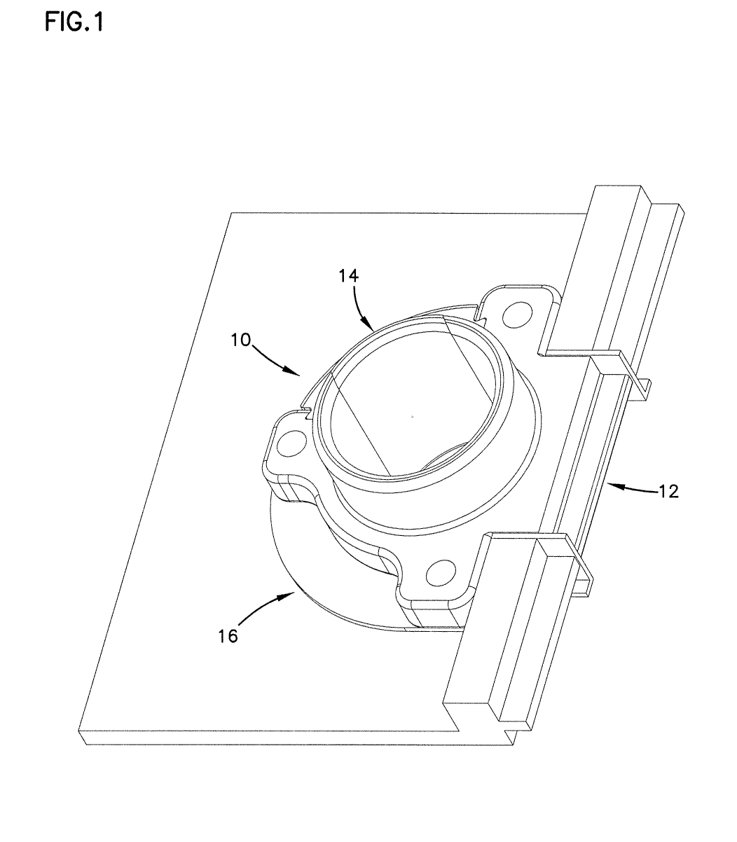

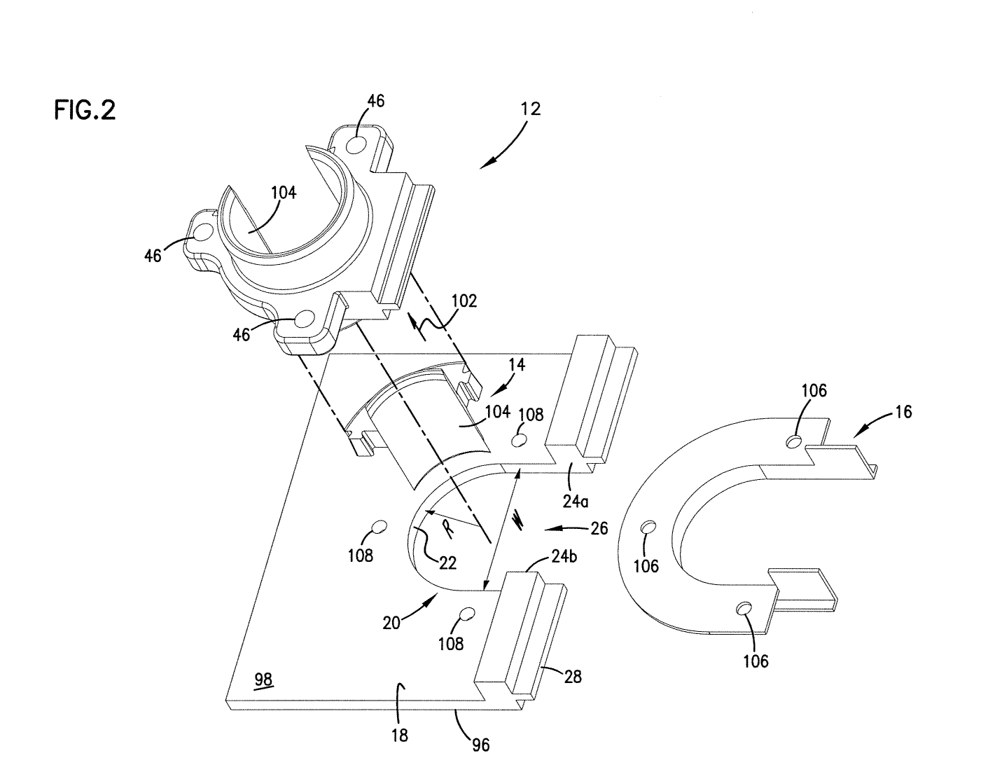

Referring now to FIGS. 1 and 2, a cable seal assembly, generally designated 10, is shown. The cable seal assembly 10 includes a first housing member, generally designated 12, a second housing member, generally designated 14, and a sealing member, generally designated 16. In the subject embodiment, the cable seal assembly 10 is mounted to a top wall 18 (a portion of which is shown in FIGS. 1 and 2) of a thin-walled enclosure. As shown in FIG. 2, the top wall 18 includes a slot, generally designated 20. In the subject embodiment, the slot 20 includes an end wall 22, first and second sidewalls 24a, 24b, and an open end 26. In the subject embodiment, the end wall 22 is formed in a semi-circular shape having a radius R, which is tangent to the first and second sidewalls 24a, 24b. It will be understood, however, that the scope of the present disclosure is not limited to the end wall 22 being semi-circular in shape. The first and second sidewalls 24a, 24b extend from the end wall 22 toward an end surface 28 of the top wall 18 where the first and second sidewalls 24a, 24b define the open end 26. The first and second sidewalls 24a, 24b of the slot 20 are generally parallel to each other and separated by a distance W. In the subject embodiment, and by way of example only, the distance W is about 1.5 inches.

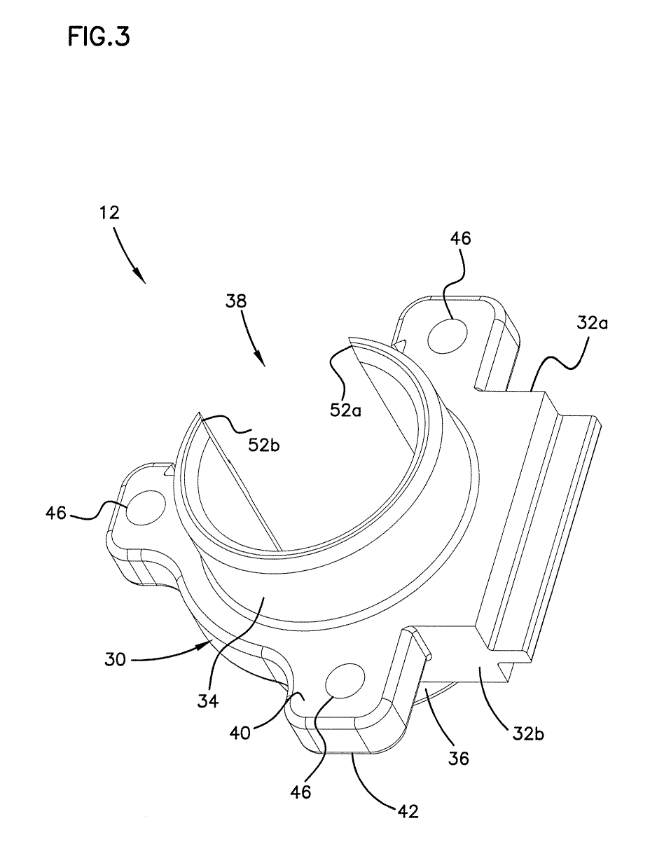

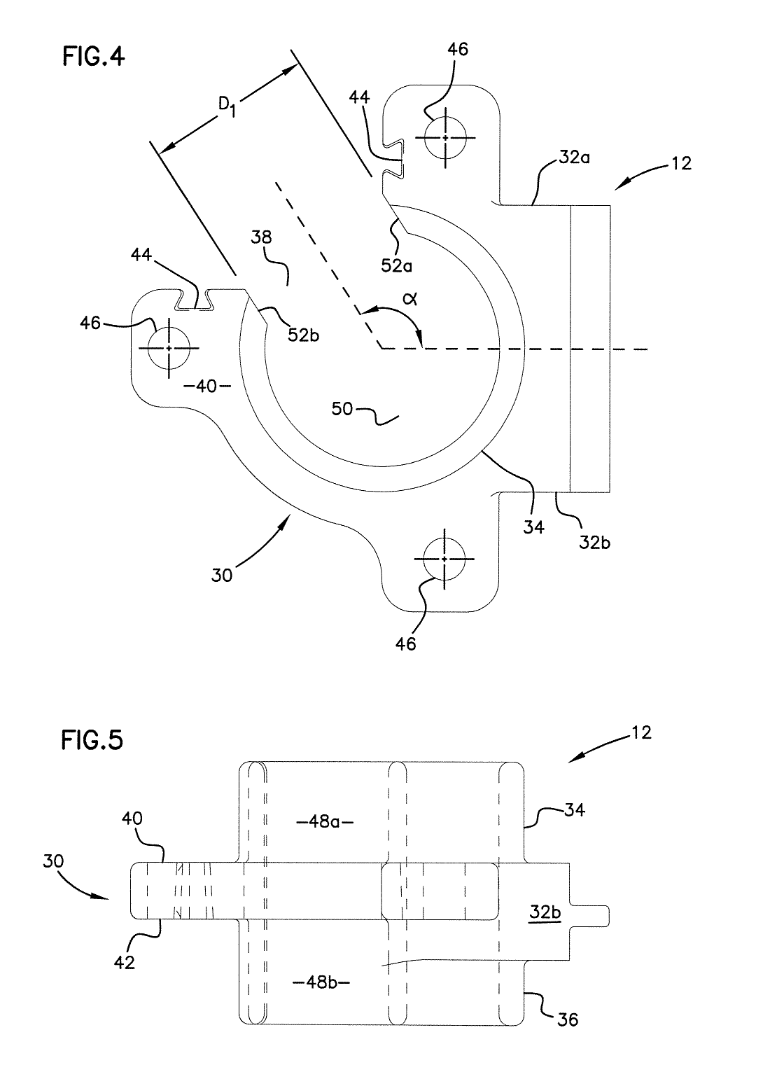

Referring now to FIGS. 3-5, the first housing member 12 will be described. The first housing member 12 includes a flange portion, generally designated 30, first and second side portions 32a, 32b, first and second protrusion portions 34, 36, and a cut-out portion 38. The flange portion 30 includes a top surface 40 and a bottom surface 42. In the subject embodiment, the flange portion 30 defines tab recesses 44 (best shown in FIG. 4), which extend through the top and bottom surfaces 40, 42. The tab recesses 44 have a taper such that the tab recesses 44 disposed on the top surface 40 of the flange portion 30 are smaller than the tab recesses 44 disposed on the bottom surface 42. This taper shall be described in more detail subsequently. The flange portion 30 further includes a plurality of mounting holes 46.

The first and second protrusion portions 34, 36 extend outwardly from the top and bottom surfaces 40, 42 of the flange portion 30, respectively. In the subject embodiment, the first and second protrusion portions 34, 36 are generally cylindrical in shape and have outer diametrical surfaces 48a, 48b (best shown in FIG. 5), respectively. The first and second protrusion portions 34, 36 cooperate to define a central axial passage 50 through the first housing member 12, the purpose of which will be described subsequently.

The cut-out portion 38 of the first housing member 12 is an axial passage that radially extends from the central axial passage 50 through the flange portion 30 and the first and second protrusion portions 34, 36. The cut-out portion 38 is defined by axial sides 52a, 52b in the flange portion 30 and the first and second protrusion portions 34, 36. In the subject embodiment, the axial sides 52a, 52b are generally parallel and separated by a distance D₁. It will be understood, however, that the scope of the present disclosure is not limited to the sides 52a, 52b of the cut-out portion 38 being generally parallel. In the subject embodiment, and by way of example only, the distance D₁ is about 0.8 inches.

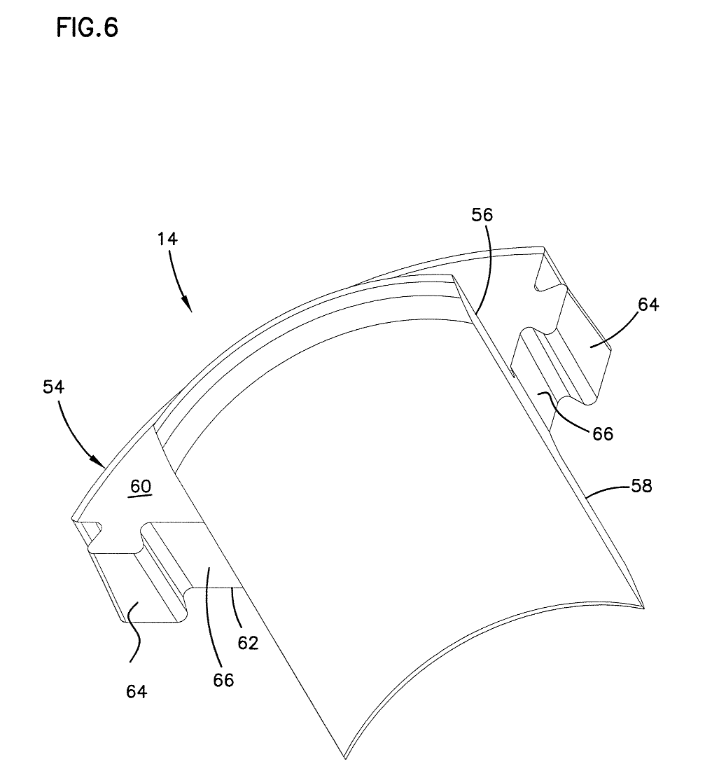

Referring now to FIGS. 6-8, the second housing member 14 will be described. The second housing member 14 includes a mating flange portion, generally designated 54, and first and second mating protrusion portions 56, 58. The mating flange portion 54 includes an upper surface 60 and a lower surface 62. In the subject embodiment, the mating flange portion 54 further includes tabs 64 that protrude from side surfaces 66 of the mating flange portion 54. As best shown in FIG. 8, the tabs 64 are tapered with the outer perimeter of the tabs 64 at the upper surface 60 being smaller than the outer perimeter of the tabs 64 at the lower surface 62. The purpose for this taper will be described subsequently.

The first and second mating protrusions 56, 58 extend outwardly from the upper and lower surfaces 60, 62 of the mating flange portion 54, respectively. In the subject embodiment, the first and second mating protrusion portions 56, 58 are generally cylindrical in shape and define outer diametrical surfaces 68a, 68b (best shown in FIG. 8), respectively. The first and second mating protrusions 56, 58 further define walls 70a, 70b. In the subject embodiment, the walls 70a, 70b are generally parallel and are separated by a distance D₂, although it will be understood by those skilled in the art that the scope of the present disclosure is not limited to the walls 70a, 70b being parallel.

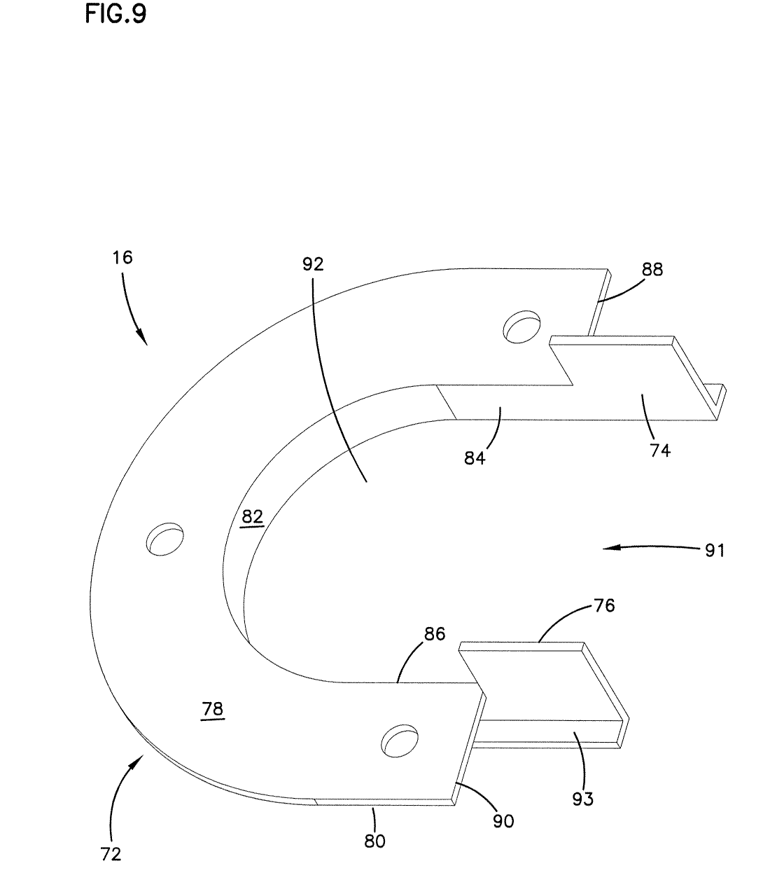

Referring now to FIGS. 9-11, the sealing member 16 will be described. The sealing member 16 includes a body portion, generally designated 72, a first leg portion 74, and a second leg portion 76. The body portion 72 includes a top sealing surface 78, a bottom sealing surface 80, and a side sealing wall 82 having a first end portion 84 and a second end portion 86. In the subject embodiment, the body portion 72 is semi-circular in shape between the first end portion 84 and the second end portion 86 of the side sealing wall 82 and has a radius R₁, which includes a thickness t of the side sealing wall 82. It will be understood, however, that the scope of the present disclosure is not limited to the body portion 72 having a semi-circular shape. The body portion 72 further includes first and second ends 88, 90. The first leg portion 74 extends outwardly from the first end portion 84 of the side sealing wall 82 at the first end 88 of the body portion 72 such that the first leg portion 74 is coplanar with the first end portion 84 of the side sealing wall 82. The second leg portion 76 extends outwardly from the second end portion 86 of the side sealing wall 82 at the second end 90 of the body portion 72 such that the second leg portion 76 is coplanar with the second end portion 86 of the side sealing wall 82. As shown in FIGS. 9-11, this configuration of the first and second leg portions 74, 76 and the body portion 72 results in the sealing member 16 being substantially U-shaped. In the subject embodiment, the first and second leg portions 74, 76 are about perpendicular to the top sealing surface 78 of the body portion 72. The first and second leg portions 74, 76 define a passageway 91 having a width W₁ that leads to a center opening 92 defined by the body portion 72. In the subject embodiment, and by way of example only, the width W₁ of the passageway 91 is about 1.4 inches.

The sealing member 16 further includes a lip 93 disposed opposite from the body portion 72 along the side sealing wall 82. The lip 93, the body portion 72 and the side sealing wall 82 cooperatively define a channel 94, the purpose of which will be described in greater detail subsequently.

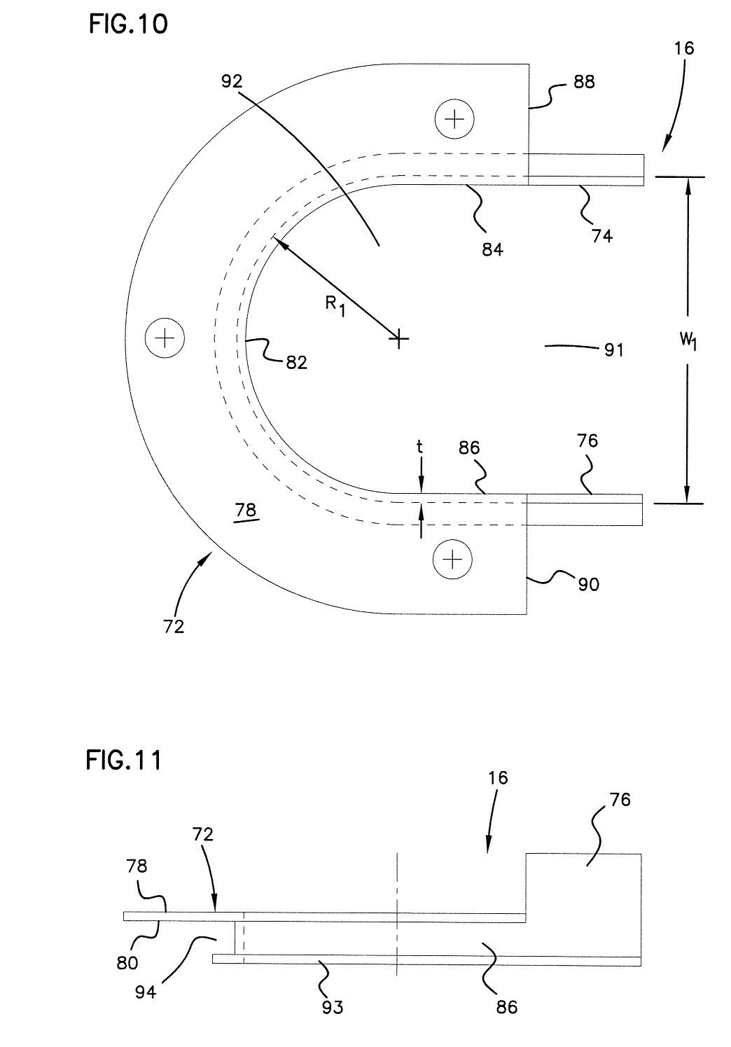

Referring now to FIGS. 2 and 9-11, the installation of the sealing member 16 in the slot 20 of the enclosure will be described. The sealing member 16 is placed in the slot 20 in the top wall 18 of the enclosure such that the top wall 18 is disposed in the channel 94 of the sealing member 16 with the lip 93 disposed against an interior surface 96 of the top wall 18 and the bottom sealing surface 80 of the sealing member 16 disposed against an exterior surface 98 of the top wall 18. In the subject embodiment, the semi-circular body portion 72 abuts the semi-circular end wall 22. To ensure proper sealing between the body portion 72 and the end wall 22, the radius R₁ of the body portion 72 should be about equal to the radius R of the end wall 22. With the body portion 72 disposed against the end wall 22, the first and second leg portions 74, 76 of the sealing member 16 are disposed against the first and second sidewalls 24a, 24b, respectively, of the slot 20. To ensure proper sealing between the first and second leg portions 74, 76 of the sealing member 16 and the first and second sidewalls 24a, 24b of the slot 20, the width W₁ (shown in FIG. 10) of the passageway 91 (plus two times the thickness t of the sealing member 16) should be about equal to the distance W (shown in FIG. 2) between the first and second sidewalls 24a, 24b of the slot 20. In addition, the first and second leg portions 74, 76 cover the entire surface of the first and second sidewalls 24a, 24b.

Referring now to FIGS. 2-8 and 12, the assembly of the first and second housing members 12, 14 will be described. As stated above, the first housing member 12 defines the cut-out portion 38. The cut-out portion 38 is used to position the first housing member 12 around a cable 100 such that an axial length of the cable 100 extends through the central axial passage 50. With the cable 100 disposed in the central axial passage 50, the second housing member 14 is assembled to the first housing member 12. As previously stated, the tabs 64 on the second housing member 14 are tapered with the outer perimeter of the tabs 64 at the upper surface 60 being smaller than the outer perimeter of the tabs 64 at the lower surface 62. In addition, the tab recesses 44 are tapered such that the tab recesses 44 disposed on the top surface 40 of the flange portion 30 are smaller than the tab recesses 44 disposed on the bottom surface 42. This taper allows for only one-way engagement and disengagement between the tabs 64 and the tab recesses 44. In order to engage the tabs 64 and the tab recesses 44, the upper surface 60 of the tabs 64 must be inserted in the tab recesses 44 at the bottom surface 42. The tabs 64 are engaged with the tab recesses 44 by sliding the tabs 64 in the tab recesses 44 in an axial direction 102 (shown as an arrow in FIG. 2) that extends from the bottom surface 42 to the top surface 40. The tabs 64 are inserted into the tab recesses 44 until the lower surface 62 of the second housing member 14 is about coplanar with the bottom surface 42 of the first housing member 12.

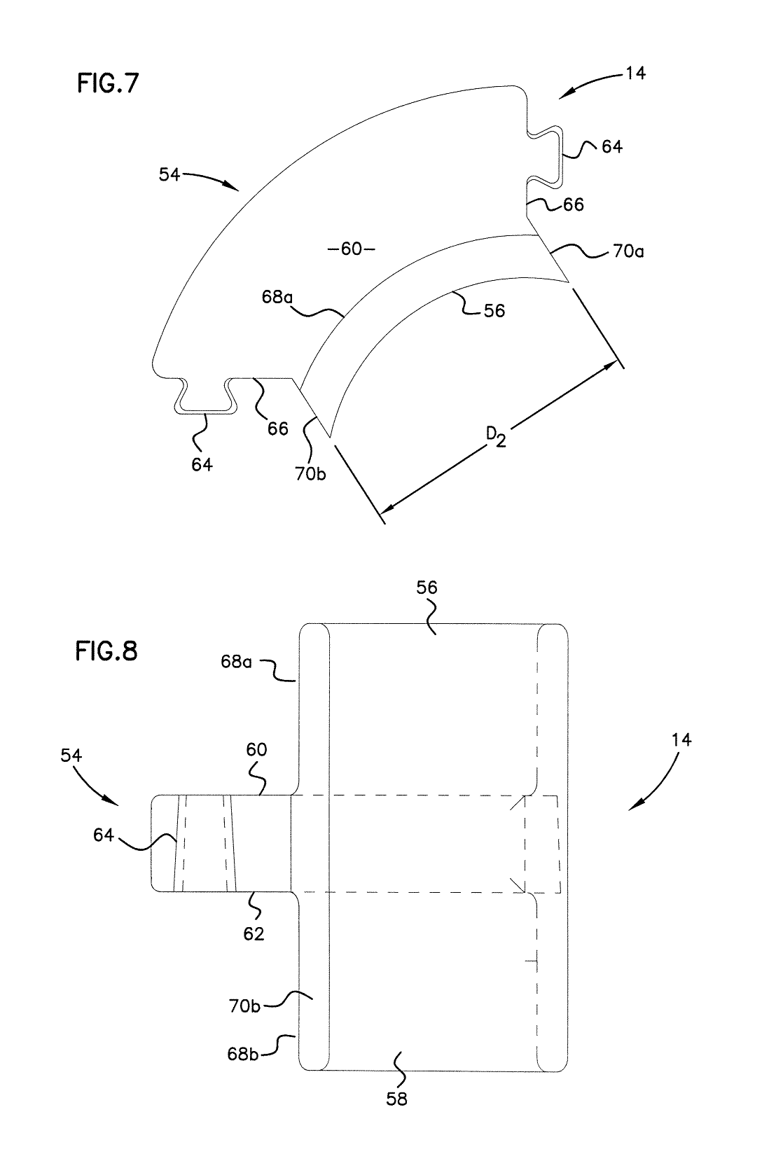

With the tabs 64 properly inserted in the tab recesses 44, the walls 70a, 70b of the second housing member 14 are adjacent to the sides 52a, 52b of the first housing member 12. In order to minimize the risk of water or other environmental contaminants from entering the enclosure between the sides 52a, 52b of the first housing member 12 and the walls 70a, 70b of the second housing member 14, the distance D₁ (shown in FIG. 4) should only be slightly greater than the distance D₂ (shown in FIG. 7). With the sides 52a, 52b of the first housing member 12 and the walls 70a, 70b of the second housing member 14 adjacent to each other, the first and second protrusion portions 34, 36 of the first housing member 12 and the first and second mating protrusion portions 56, 58 of the second housing member 14 cooperatively enclose the central axial passage 50 and define an inner surface 104 of the central axial passage 50. In the subject embodiment, the first housing member 12 defines a portion of the inner surface 104 that is greater than or equal to three-quarters of the total inner surface 104. The second housing member 14 defines a complementary portion of the inner surface 104 that is less than or equal to one-quarter of the total inner surface 104.

After the cable 100 is inserted in the central axial passage 50, the first and second housing members 12, 14 are mounted in the slot 20 of the enclosure. The first and second housing members 12, 14 are inserted into the slot 20 such that the bottom surface 42 of the flange portion 30 of the first housing member 12 and the lower surface 62 of the mating flange portion 54 of the second housing member 14 are in sealing engagement with the top sealing surface 78 of the body portion 72 of the sealing member 16. In a preferred embodiment, the first and second side portions 32a, 32b of the first housing member are in sealing engagement with the first and second leg portions 74, 76 of the sealing member 16, respectively. In a preferred embodiment, a portion of the outer diametrical surface 48b of the second protrusion portion 36 of the first housing member 12 and a portion of the outer diametrical surface 68b of the second mating protrusion portion 58 of the second housing member 14, which are disposed in the center opening 92 of the sealing member 16, are in sealing engagement with the side sealing wall 82 of the sealing member 16. Therefore, in one embodiment, the sealing member 16 can seal between the first and second sidewalls 24a, 24b of the slot 20 and the first and second side portions 32a, 32b of the first housing member 12, the end wall 22 of the slot and the portions of the outer diametrical surfaces 48b, 68b of the second protrusion portion 36 and the second mating protrusion portion 58, respectively, and the exterior surface 98 of the top wall 18 and the bottom surface 42 of the flange portion 30 and the posterior surface 62 of the mating flange portion 54. However, it will be understood that the scope of the present disclosure is not limited to the sealing member 16 sealing in all of the above described locations.

In order to minimize the risk of water or environmental contaminants entering into the enclosure through the cut-out portion 38 of the first housing member 12, the cut-out portion 38 is not oriented toward the open end 26 of the slot 20 in the top wall 18 when the first and second housing members 12, 14 are mounted in the top wall 18. Rather, the cut-out portion 38 is oriented from the open end 26 at an angle α (shown in FIG. 4) such that the outer diametrical surface 68a of the second housing member 14 abuts the side sealing wall 82 of the sealing member 16. In a preferred embodiment, and by way of example only, the angle α is about 120 degrees.

With the first and second housing members 12, 14 inserted into the slot 20 of the enclosure, a plurality of fasteners (e.g., bolts, screws, rivets, etc) is inserted through the plurality of mounting holes 46 in the flange portion 30 of the first housing member 12 and through a plurality of holes 106 in the sealing member 16. In the subject embodiment, the fasteners are in threaded engagement with a plurality of holes 108 in the top wall 18.

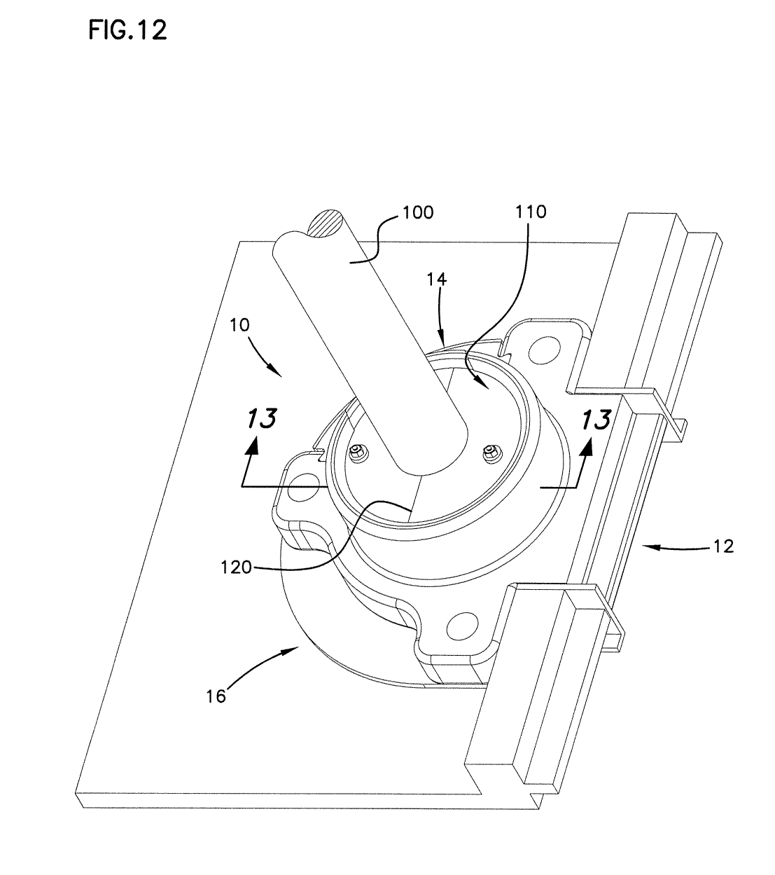

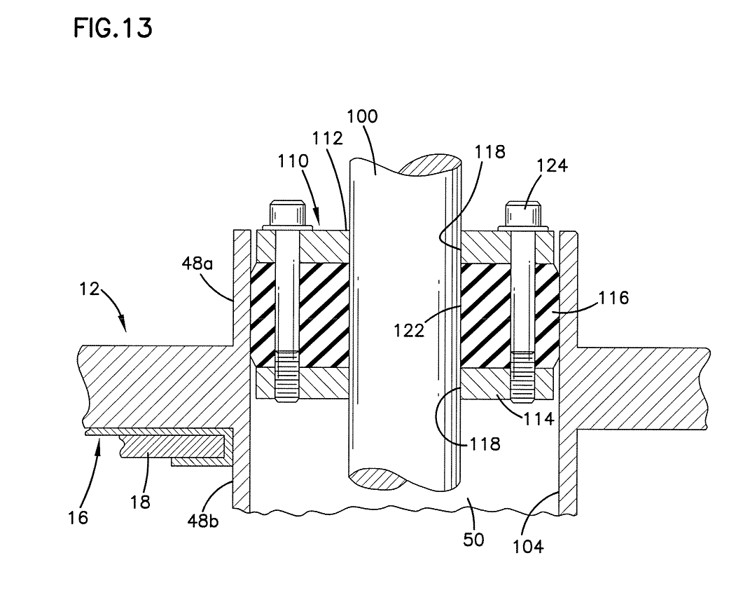

Referring now to FIGS. 12 and 13, a cable seal, generally designated 110, will be described. With the first and second housing members 12, 14 mounted to the enclosure, the cable seal 110 is positioned around the cable 100 in the central axial passage 50 in order to seal between the cable 100 and the inner surface 104 of the central axial passage 50. As the cable seal 110 is known and available commercially, the cable seal 110 will only be briefly described herein. The cable seal 110 includes a top member 112, a bottom member 114, and a seal 116 disposed between the top and bottom members 112, 114. Each of the top and bottom members 112, 114 of the cable seal 110 include an opening 118 and a split 120 (shown in FIG. 12) that extends through the opening 118 and divides each of the top and bottom members 112, 114 into two pieces. The split 120 allows the top and bottom members 112, 114 to be positioned around the cable 100. The seal 116 includes a thru-hole 122 and a radial split that extends from the thru-hole 122 to the outer periphery of the seal 116. The radial split allows the cable to be positioned within the thru-hole 122.

With the cable seal 110 surrounding the cable 100, the cable seal 110 is inserted into the central axial passage 50. In order to provide proper sealing between the cable seal 110, the cable 100, and the central axial passage 50, a fastener 124 (shown here in as a bolt), which abuts the top member 112, threadedly engages the bottom member 114. As the fastener 124 is rotated in a tightening direction, the fastener 124 pulls the bottom member 114 toward the top member 112 thereby compressing the seal 116. As the seal 116 compresses, the diameter of the thru-hole 122 constricts toward the cable 100 while the outer circumferential periphery of the seal 116 expands toward the inner surface 104 of the central axial passage 50. The fastener 124 is rotated in the tightening direction until the cable seal 110 is in sealing engagement with the cable 100 and the inner surface 104 of the cable passage 50.

One of the many potential advantages of the subject embodiment of the present disclosure is that the cable seal assembly 10 provides a sufficient sealing surface (the inner surface 104) for the cable seal 110. As the walls of the enclosure are thin, the cable seal 110 would not be able to effectively seal between the top wall 18 of the enclosure and the cable 100 without the use of the cable seal assembly 10. However, the inner surface 104 of the cable seal assembly 10 provides a surface of adequate length against which the cable seal 110 can seal.

Another potential advantage of the subject embodiment of the present disclosure is that the cut-out portion 38 allows the cable to be positioned inside the central axial passage 50 without requiring an end of the cable to be inserted through the central axial passage 50. This cut-out portion 38 allows changes to be made to the enclosure, such as in the case of an automobile accident as described above, without requiring the cable to be cut and reterminated.

Various modifications and alterations of this disclosure will become apparent to those skilled in the art without departing from the scope and spirit of this disclosure, and it should be understood that the inventive scope of this disclosure is not to be unduly limited to the illustrative embodiments set forth herein.

What is claimed is:

1. A cable seal assembly comprising:
a sealing member defining a passageway that extends from a center opening of the sealing member through the periphery of the sealing member;
a first housing member adapted to be received in the passageway and the center opening of the sealing member, wherein the first housing member defines a cutout portion; and
a second housing member adapted to be received in the center opening of the sealing member and engaged with the cutout portion of the first housing member, wherein the first housing member and the second housing member cooperatively define a central axial passage having an inner surface.

2. A cable seal assembly as claimed in claim 1, further comprising a cable seal in sealing engagement with the central axial passage, the cable seal including a top member, a bottom member, a seal disposed between the top member and the bottom member, and a compression member adjacent to the top member and engaged with the bottom member, wherein the compression member selectively compresses the seal expanding the periphery of the seal into sealing engagement with the inner surface of the central axial passage.

3. A cable seal assembly as claimed in claim 1, wherein the sealing member is a gasket.

4. A cable seal assembly as claimed in claim 3, wherein the gasket is substantially U-shaped.

5. A cable seal assembly as claimed in claim 1, wherein the second housing member includes tabs that interconnect with tab recesses in the first housing member.

6. A cable seal assembly as claimed in claim 5, wherein the tabs and the tab recesses are tapered to provide one-way engagement/disengagement.

7. A cable seal assembly as claimed in claim 1, wherein the first housing member defines a portion of the inner surface that is greater than or equal to three-quarters of the total inner surface and the second housing member defines a complementary portion of inner surface that is less than or equal to one-quarter of the total inner surface.

8. A cable seal assembly as claimed in claim 1, wherein the central axial passage through the first housing member and the second housing member is generally cylindrical.

9. A cable seal assembly comprising:
a sealing member having a first leg portion, a second leg portion, and a body portion including a front sealing surface and a side sealing wall, wherein the first leg portion extending from a first end of the body portion and the second leg portion extending from a second end of the body portion define a passageway leading to a center opening in the sealing member;
a first housing member disposed in the passageway and center opening of the sealing member having a cut-out portion, wherein the first housing member is in sealing contact with the front sealing surface and the side sealing wall of the body portion and the first and second leg portions of the sealing member; and
a second housing member disposed in the center opening of the sealing member and being in engagement with the cut-out portion of the first housing member, wherein the second housing member is in sealing contact with the front sealing surface and the side sealing wall of the body portion of the sealing member.

10. A cable seal assembly as claimed in claim 9, wherein the sealing member includes a lip that cooperatively defines a channel with the back portion and the side sealing wall.

11. A cable seal assembly as claimed in claim 9, wherein the sealing member is a gasket.

12. A cable seal assembly as claimed in claim 11, wherein the first leg portion and the second leg portion are about perpendicular to the front sealing surface.

13. A cable seal assembly as claimed in claim 9, wherein the second housing member includes tabs that interconnect with tab recesses in the first housing member.

14. A cable seal assembly as claimed in claim 13, wherein the tabs and the tab recesses are tapered to provide one-way engagement and disengagement.

15. A cable seal assembly as claimed in claim 9, wherein the first and second housing members cooperatively define a central axial passage having an inner surface through the first housing member and the second housing member.

16. A cable seal assembly as claimed in claim 15, wherein the first housing member defines a portion of the inner surface that is greater than or equal to three-quarters of the total inner surface and the second housing member defines a complementary portion of inner surface that is less than or equal to one-quarter of the total inner surface.

17. A cable seal assembly as claimed in claim 9, further comprising a cable seal disposed in the central axial passage defined by the first housing member and the second housing member.

18. A cable sealing system comprising:
a sealing member defining a passageway that extends from a center opening of the sealing member through the periphery of the sealing member;
a first housing member disposed in the passageway and center opening of the sealing member, wherein the first housing member defines a cutout portion;
a second housing member disposed in the center opening of the sealing member and engaged with the cutout portion of the first housing member, wherein the first housing member and the second housing member cooperatively define a central axial passage having an inner surface;
a fiber optic cable disposed in the central axial passage; and
a cable seal in sealing engagement with the central axial passage and the fiber optic cable, the cable seal including a top member, a bottom member, a seal that is disposed between the top member and the bottom member and includes an outer periphery and a thru-hole, a compression member adjacent to the top member and engaged with the bottom member, wherein the compression member selectively compresses the seal expanding the outer periphery of the seal into sealing engagement with the inner surface of the central axial passage and constricting the thru-hole into sealing engagement with the fiber optic cable.

19. A cable sealing system as claimed in claim 18, wherein the first housing member defines a portion of the inner surface that is greater than or equal to three-quarters of the total inner surface and the second housing member defines a complementary portion of inner surface that is less than or equal to one-quarter of the total inner surface.

20. A method of installing a cable seal assembly comprising the steps of:
mounting a sealing member in a slot in a wall of an enclosure, wherein the sealing member includes a center opening and a passageway that extends from the center opening through a periphery of the sealing member;
inserting an axial length of a fiber optic cable through a cutout portion of a first housing member and into a central axial passage of the first housing member;
coupling a second housing member to the cutout portion of the first housing member, wherein the first and second housing members cooperatively define an inner surface of the central axial passage;
mounting the first and second housing members to the wall of the enclosure, wherein the first housing member is disposed in the passageway and center opening of the sealing member and the second housing member is disposed in the center opening of the sealing member;
positioning a cable seal around the fiber optic cable;
inserting the cable seal into the central axial passage; and
actuating a compression member of the cable seal so that an outer periphery of the cable seal expands to sealingly engage with the inner surface of the central axial passage and a thru-hole of the cable seal constricts to sealingly engage the fiber optic cable.
